(19) United States
(12) Patent Application Publication
(10) Pub. No.: US 2026/0242634 A1
(43) Pub. Date: Aug. 20, 2026

(54) SPRAYABLE MOISTURE CURABLE RESIN COMPOSITION

(71) Applicant: Kaneka Americas Holding, Inc., Pasadena, TX (US)

(72) Inventors: Jonathan Barrus, Pasadena, TX (US); Jonathan Barrus, Pasadena, TX (US); Yoshiki Nakagawa, Pasadena, TX (US); Shota Koya, Pasadena, TX (US)

(73) Assignee: Kaneka Americas Holding, Inc., Pasadena, TX (US)

(21) Appl. No.: 19/471,355

(22) PCT Filed: Mar. 29, 2024
(86) PCT No.: PCT/US2024/022153

§ 371 Date: Sep. 30, 2025

Related U.S. Application Data
(60) Provisional application No. 63/456,218, filed on Mar. 31, 2023.

(51) Int. Cl. C09D 183/04; C09D 171/02

(52) U.S. Cl. CPC C09D 183/04; C09D 171/02

(57) ABSTRACT

Provided is a curable resin composition comprising a polymer (P), and a plasticizer and/or a diluent. The curable composition has a spray index (SI) according to (SI)=μ*SG/TI, where μ is the viscosity in Pa*s determined at 1000 s−1, TI is the thixotropic index calculated by the 2 rpm/10 rpm Brookfield viscosity, and SG is the specific gravity. Compositions having a spray index of less than 1.3 are sprayable. Also provided are a cured resin composition, a structure comprising the cured or curable resin composition, and a method of providing a curable resin composition and spraying onto a substrate.

### BACKGROUND

A moisture curable resin composition is often used as a coating material to protect a structure. Such compositions may include a moisture curable resin, a catalyst, and a plasticizer. Conventional means for applying the coating includes spraying a curable composition onto a substrate and curing the composition while adhered to the substrate. Current formulation methods have difficulty in predicting the suitability of a formulation for spraying. Present methods consider the viscosity as a predictor of sprayability, but the methods break down when considering high boiling point petroleum distillates or higher molecular weight plasticizers.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a curable resin composition comprising a polymer (P), and a plasticizer and/or a diluent; wherein the curable composition has a spray index (SI) according to (SI)=μ*SG/TI, wherein μ is the viscosity in Pa*s determined at 1000 s⁻¹, and wherein TI is the thixotropic index calculated by the 2 rpm/10 rpm Brookfield viscosity, and wherein SG is the specific gravity; and wherein the spray index is less than 1.3.

In another aspect, embodiments disclosed herein relate to cured resin composition of the curable resin composition described above.

In another aspect, embodiments disclosed herein relate to a structure, comprising a substrate; and a membrane disposed on the substrate, wherein the membrane comprises at least one layer of the cured resin composition of the curable resin composition as described above.

In another aspect, embodiments disclosed herein relate to a method comprising providing a curable resin composition as described above and spraying the curable resin composition onto a substrate.

Other aspects and advantages of the claimed subject matter will be apparent from the following description and the appended claims.

### DETAILED DESCRIPTION

The present disclosure provides a means of characterizing and predicting the sprayability of a curable resin composition via a spray index. The spray index considers the viscosity, thixotropic index, and specific gravity of a fully formulated composition to indicate whether the composition will be sprayable.

### Curable Resin Composition

The present disclosure generally relates to a sprayable curable resin composition comprising a moisture curable resin and a non-solvent plasticizer and/or diluent (which are non-volatile organic compounds). The curable resin compositions exhibit thixotropic behavior, which allows the compositions to be sprayed onto a substrate, such as a vertical surface, and to coat the substrate with limited sag prior to and during curing.

In one aspect, embodiments disclosed herein relate to a curable resin composition comprising a moisture curable resin that may be a polymer (P) containing moisture curable functional groups, a plasticizer and/or diluent having a boiling point greater than or equal to 260° C., and (optionally) a catalyst to promote curing. The curable resin composition exhibits a spray index that indicates a suitability for spraying applications.

### Moisture Curable Resin

In one or more embodiments, the curable resin composition comprises a moisture curable resin that may be a polymer (P) containing curable functional groups. Polymers (P) according to one or more embodiments have a polyether main chain comprising alkylene oxide recurring units. The alkylene oxide recurring units may be according to formula (1):

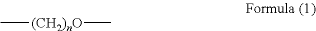

wherein n is an integer ranging from 2 to 4.

In one or more embodiments, the polymer (P) may be a polyethylene oxide, a polypropylene oxide, or a polybutylene oxide.

The polymer (P) comprises curable functional groups, which may be moisture curable functional groups. For example, the curable functional groups may be reactive silicon groups represented by the general formula (2):

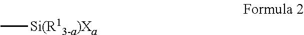

R¹ represents an alkyl group having 1 to 20 carbon atoms, an aryl group having 6 to 20 carbon atoms, or an aralkyl group having 7 to 20 carbon atoms. X represents a hydrolyzable group. Each X is the same or different when two or more X are present and a is an integer from 1 to 3. When a is 1, each R¹ may be the same or different, and when a is 2 or 3, each X may be the same or different.

In one or more embodiments, the moisture curable resin comprises trimethoxysilyl, methyldimethoxysilyl, triethoxysilyl, methyldiethoxysilyl groups, or combinations thereof.

Specific examples of the moisture curable resin may include, but are not limited to, KANEKA MS POLYMER@S203H, S303H, S327, and S227 and KANEKA SILYL® MA904, SAX350, SAX260, SAX400, SAX530, and SAX590.

The polymer (P) may have a number of the reactive silicon groups in a range of from about 0.5 to about 6 per single polymer chain, such as a lower limit selected from any one of 0.5, 0.6, 0.7, 0.8, 0.9, 1.0 and 1.1, to an upper limit selected from any one of 3, 4, 5, and 6, where any lower limit may be paired with any upper limit.

The polymer (P) may have linear or branched structures, and the number-average molecular weight (Mn) may be in a range of from about 500 to about 100,000, such as a lower limit selected from any one of 500, 1000, 2000, and 3000 to an upper limit selected from any one of 10,000, 15,000, 50,000, and 100,000, where any lower limit may be paired with any upper limit. The Mn may be measured by gel permeation chromatography, such as with the use of a TOSOH HLC-8120GPC system equipped with TSK-GEL H type columns (TOSOH CORPORATION), and using a THF mobile phase.

The polymer (P) may have a molecular weight distribution (Mn/Mw), or a ratio of Mn and weight-average molecular weight (Mw), of 1.6 or less, such as 1.6 or less, 1.4 or less, 1.2 or less, or 1.1 or less.

The reactive silicon group of the moisture curable resin may be bonded to a terminal end of the polymer chain, or along the polymer chain between the terminal ends; or a plurality of the reactive silicon groups may be bonded to both the terminal ends and along the polymer chain.

In one or more embodiments, the curable resin composition may comprise the polymer (P) in an amount of about 10 to 60 wt %. For example, the amount of the polymer (P) in the curable resin composition may range from a lower limit selected from any one of 10, 15, 20, 25, 30, or 35 wt % to an upper limit selected from any one of 40, 45, 50, 55, or 60 wt %, where any lower limit may be paired with any upper limit.

### Plasticizers and Diluents

In one or more embodiments, the curable resin composition comprises at least one plasticizer and/or a diluent. Plasticizers and/or diluents according to the present disclosure are non-volatile organic compounds. The term non-volatile organic compound is defined as a compound having a boiling point of greater than or equal to 260° C.

In one or more embodiments, the curable resin composition includes at least one plasticizer. The plasticizer may be (for example) small molecules (i.e. molecules having a molecular weight of less than 1000 g/mol), oils, waxes, oligomers, low molecular weight polymers, or other suitable substances for decreasing viscosity or increasing the plasticity of polymer (P). Suitable plasticizers may include, but are not limited to, benzoate, phthalates, cyclohexyl diesters, glycol diester, petroleum distillate and combinations thereof. Specific examples of the plasticizer may include isodecyl benzoate (e.g., Jayflex™ MB10 (“MB10”) available from ExxonMobil), triethylene glycol bis(2-ethylhexanoate) “TEG-EH” (e.g. Oxfilm 351 available from OXEA), diisononyl phthalates (e.g., Jayflex™ DINP), 1,2-cyclohexane dicarboxylic acid diisononyl ester (Hexamoll DINCH available from BASF), Fluid D 170 LPP available from TotalEnergies, and combinations thereof.

In one or more embodiments, the plasticizer is used alone, used in combinations, or used in combinations with another higher viscosity plasticizer (plasticizer blend). The higher viscosity plasticizer refers to a plasticizer having a Brookfield viscosity of at least 25 cP at 23° C. The plasticizer or at least one plasticizer in the plasticizer blend contained in the curable resin composition has a dynamic viscosity of less than 25 cP at 23° C., when measured with a rotational, or a Brookfield viscometer (“Brookfield viscosity”). In one or more embodiments, the plasticizer has a viscosity in a range of from about 1 cP to about 25 cP at 23° C., such as a lower limit selected from any one of 1, 2, 4, and 5 cP, to an upper limit selected from any one of 15, 20, and 25 cP, where any lower limit may be paired with any upper limit. For example, MB10, D170 LPP, and TEG-EH may have a dynamic viscosity of 13 cP, 15 cP, and 17 cP respectively, when measured with a Brookfield LV viscometer with an RV-01 spindle at a temperature of 23° C. and at 12 revolutions per minute (rpm).

In one or more embodiments, the amount of the plasticizer in the curable resin composition is in a range of from about 10 wt % to about 60 wt %, such as a lower limit selected from any one of 10, 15, and 20 wt %, to an upper limit selected from any one of 30, 40, 50, and 60 wt %, where any lower limit may be paired with any upper limit.

In one or more embodiments, the plasticizer is substantially free of volatile organic compounds. A plasticizer “substantially free” of volatile organic compounds refers to a plasticizer having volatile organic compounds of about less than 5 wt % of the total weight of the plasticizer, such as having less than 5, 4, 3, 2, 1, 0.5, 0.1, 0.05, or 0.01 wt % of volatile organic compounds based on the total weight of the plasticizer. In one or more embodiments, the plasticizer contains 0 wt % volatile organic compounds based on the total weight of the plasticizer.

In one or more embodiments, the plasticizer has a boiling point of at least 260° C., or in a range from about 260° C. to about 500° C., such as in a range from a lower limit selected from any one of 260, 270, 280, 290, and 300° C. to an upper limit selected from any one of 400, 410, 420, 430, 440, 450, and 500° C., where any lower limit may be paired with any upper limit.

### Catalyst

In one or more embodiments, the curable resin composition includes a catalyst. Suitable catalysts may include, but are not limited to, organotin catalysts such as the di-butyltin-based Neostann U-220H, a zinc complex (e.g. “K-KAT 670” available from King Industries); a titanium complex, such as diisopropoxy-bisethylacetoacetatotitanate (e.g. “Tyzor PITA” available from Dorf Ketal); or carboxylic acid metal salt catalyst, such as the potassium neodecanoate TIB KAT K25.

In one or more embodiments, the amount of the catalyst in the curable resin composition is in a range of from about 0.1 wt % to about 10 wt %, such as a lower limit selected from any one of 0.1, 0.25, 0.5, 1, 1.5, and 2 wt %, to an upper limit selected from any one of 2, 3, 4, 5, and 10 wt %, where any lower limit may be paired with any upper limit.

### Additives

In one or more embodiments, the curable resin composition includes additives. The curable resin composition may include any suitable additives, such as polymers different from the polymer (P), fillers, pigments, thixotropic agents (anti-sagging agents), UV inhibitors/absorbers, stabilizers, antioxidants, dehydration agents, adhesion promoters, flame retardants, curability modifiers, lubricants, antifungal agents, and combinations thereof.

Examples of polymers different from the polymer (P) may include, but are not limited to, liquid epoxy resins (such as Epon® 828 available from Hexion).

Examples of the fillers may include, but are not limited to, ground and precipitated calcium carbonate (CaCO₃), magnesium carbonate, diatomite, calcined clay, clay, talc bentonite, reinforcing fillers such as fumed silica, precipitated silica, crystalline silica, and fibrous fillers such as glass fibers and filaments. Specific examples of the CaCO₃ filler may include Hubercarb®Q3T, Hubercarb®G2T, and Hubercarb®G8 (available from Huber Engineered Materials).

Examples of pigments may include, but are not limited to, titanium dioxide (TiO₂) and carbon black.

Examples of thixotropic agents may include, but are not limited to, hydrogenated castor oil, organic amid wax, organic bentonite, and calcium stearate.

Examples of UV inhibitors/absorbers may include, but are not limited to, benzophenone compounds, benzotriazole compounds, triazine compounds, salicylate compounds, substituted tolyl compounds, and metal chelate compounds.

Examples of stabilizers may include, but are not limited to, hindered amine light stabilizer (HALS), benzotriazole compounds, and benzoate compounds.

Examples of antioxidants may include, but are not limited to, hindered phenolic antioxidants such as Irganox®245, 1010, and 1076 (available from BASF).

Examples of dehydration agents may include, but are not limited to, alkoxysilane compounds such as n-propyl trimethoxy silane, vinyl trimethoxy silane, and octyl trimethoxy silane.

Examples of adhesion promotors may include, but are not limited to, silane coupling agents, and reaction products of silane coupling agents such as isocyanate-group-containing silanes, amino-group-containing silanes (aminosilane), mercapto-group-containing silanes, epoxy-group-containing silanes, vinylically unsaturated group containing silanes, and halogen-containing silanes, amino-modified-silyl polymers, unsaturated aminosilane complexes, phenylamino long chain alkyl-silanes, aminosilylated silicones, and silylated polyesters.

In one or more embodiments, the curable resin composition further includes additional catalysts. Examples of additional catalysts may include amine compounds such as aliphatic primary amines, aliphatic secondary amines, aliphatic tertiary amines, and aliphatic unsaturated amines, nitrogen-containing heterocyclic compounds such as pyridine, imidazole, and amidines such as 1,8-diazabicyclo (5,4,0) undecane—7 (DBU).

In one or more embodiments, the amount of the additives in the curable resin composition is in a range of from about 0 wt % to about 60 wt %, such as a lower limit selected from any one of 0, 1, 5, 10, and 20 wt %, to an upper limit selected from any one of 40, 50, and 60 wt %, where any lower limit may be paired with any upper limit.

In one or more embodiments, the amount of the filler in the curable resin composition is in a range of from about 0 wt % to about 50 wt %, such as a lower limit selected from any one of 0, 1, 5, and 10 wt %, to an upper limit selected from any one of 40, 45, and 50 wt %, where any lower limit may be paired with any upper limit.

In one or more embodiments, the amount of the pigment in the curable resin composition is in a range of from about 0 wt % to about 10 wt %, such as a lower limit selected from any one of 0, 0.1, 0.2, 0.3, 0.4, and 0.5 wt %, to an upper limit selected from any one of 6, 7, 8, 9, and 10 wt %, where any lower limit may be paired with any mathematically compatible upper limit.

In one or more embodiments, the amount of the thixotropic agent in the curable resin composition is in a range of from about 0 wt % to about 4 wt %, such as a lower limit selected from any one of 0, 0.1, and 0.2 wt %, to an upper limit selected from any one of 1, 2, 3, and 4 wt %, where any lower limit may be paired with any upper limit.

In one or more embodiments, the amount of the stabilizer in the curable resin composition is in a range of from about 0 wt % to about 3 wt %, such as a lower limit selected from any one of 0, 0.1, and 0.2 wt %, to an upper limit selected from any one of 0.5, 1, 2, and 3 wt %, where any lower limit may be paired with any upper limit.

In one or more embodiments, the amount of the dehydration agent in the curable resin composition is in a range of from about 0 wt % to about 3 wt %, such as a lower limit selected from any one of 0, 0.1, and 0.2 wt %, to an upper limit selected from any one of 0.5, 1, 2, and 3 wt %, where any lower limit may be paired with any upper limit.

In one or more embodiments, the amount of the adhesion promoter in the curable resin composition is in a range of from about 0 wt % to about 5 wt %, such as a lower limit selected from any one of 0, 0.1, and 0.5 wt %, to an upper limit selected from any one of 2, 3, 4, and 5 wt %, where any lower limit may be paired with any upper limit.

### Method of Producing a Curable Resin Composition

In another aspect, embodiments disclosed herein relate to a method for producing a curable resin composition. The method may include mixing about 10 wt % to about 60 wt % of at least one moisture curable resin, about 10 wt % to about 60 wt % of a plasticizer, and about 0.1 wt % to about 5 wt % of a catalyst.

The mixing may be conducted with a method and equipment known in the art. In one or more embodiments, the mixing may be conducted using single shaft or multiple shaft mixers, e.g. double planetary or disperser/anchor geometries.

### Articles or Structures

Embodiments disclosed herein relate to a structure or article comprising a substrate and a membrane disposed on the substrate. The membrane comprises at least one layer of the cured resin composition of the curable resin composition. The membrane may include at least one layer of the cured resin composition of the curable resin composition as previously described, and the number of layers may be determined based on the requirements of each application. In one or more embodiments, the membrane includes a single layer of the cured resin composition. The single layer of the cured resin composition may function as a primer and a base coat. In one or more embodiments, the membrane includes a top coat disposed on the single layer of the cured resin composition. The top coat may be disposed on the surface that is opposite from the surface in contact to the substrate.

Examples of the substrate may include, but are not limited to, oriented strand board, plywood, fiberboard, foam, gypsum board, a concrete masonry unit, or cast concrete.

### Method of Coating a Substrate

In another aspect, embodiments disclosed herein relate to a method for coating a substrate with the cured resin composition of the curable resin composition. The method includes providing a curable resin composition and spraying the curable resin composition onto a substrate.

The curable resin composition may be produced as previously described. The spraying may be conducted with a method and equipment known in the art. In one or more embodiments, the spraying may be conducted with an airless hydraulic spray rig, pressurized canister, or pneumatically accelerated spray guns. The airless hydraulic spray rig may have a tip orifice size in a range of from about 0.017 to about 0.021. Examples of the airless hydraulic spray rig may include, but are not limited to, Graco X-Force handheld spray gun with 621 tip and 519 tip.

In one or more embodiments, the spraying is conducted at a pressure of equal to or less than 4000 psi, without including volatile organic compounds to the curable resin composition. In one or more embodiments, the spraying is conducted at a pressure in a range of about 50 psi to about 4000 psi, such as in a range from a lower limit selected from any one of 50, 100, and 500 psi to an upper limit selected from any one of 3000, 3500, and 4000 psi, where any lower limit may be paired with any upper limit.

In one or more embodiments, the method further includes exposing the sprayed curable resin composition to moisture and curing the sprayed curable resin composition at least until substantially cured to produce a cured resin composition of the curable resin composition. A “substantially cured” resin composition refers to a resin composition which has undergone a curing process such that no material transfer occurs upon handling with force, and the material develops the majority of targeted mechanical properties such as tensile strength, tensile, and hardness. A substantially cured resin composition may have a degree of cure of at least 50%, at least 60%, at least 70%, or at least 80%.

In one or more embodiments, the sprayed curable resin composition is exposed to air containing moisture. The air may have a relative humidity (RH) in a range of from about 25% to about 99%.

In one or more embodiments, the curing is conducted for a duration of at least 5 minutes, 10 minutes, 20 minutes, 30 minutes, 50 minutes, 100 minutes, or 150 minutes at 23° C. and 50% RH (depending on the embodiment). In one or more embodiments, the curing is conducted for a duration in a range from about 50 minutes to about 1000 minutes, such as in a range of from a lower limit selected from any one of 5 minutes, 10 minutes, 20 minutes, 30 minutes, 50 minutes, 100 minutes, and 150 minutes, to an upper limit selected from any one of 500 minutes, and 1000 minutes, 1 day, 5 days, and 10 days, where any lower limit may be paired with any upper limit.

In one or more embodiments, the curing may be conducted in a controlled manner, i.e. “controlled curing”. “Controlled curing” refers to curing of the curable resin composition under conditions for which at least one parameter that affects the cure kinetics is controlled. Such parameters may include temperature and relative humidity. It is understood that the curable resin composition does not necessarily undergo controlled curing depending on the application, and parameters such as temperature, relative humidity, and the time required to cure the resin may have varying ranges. The controlled curing may be conducted at a room temperature, such as about 23° C., and controlled humidity, such as about 50% relative humidity. In one or more embodiments, the curing is conducted at an elevated temperature such as 50° C. to accelerate full cure.

The controlled curing may be conducted for a duration of at least 5 minutes, 10 minutes, 20 minutes, 30 minutes, 50 minutes, 100 minutes, or 150 minutes (depending on the embodiment). In one or more embodiments, the controlled curing is conducted for a duration in a range from about 5 minutes to about 10 days, such as in a range of from a lower limit selected from any one of 5 minutes, 10 minutes, 20 minutes, 30 minutes, 50 minutes, 100 minutes, and 150 minutes, to an upper limit selected from any one of 500 minutes, and 1000 minutes, 1 day, 5 days, and 10 days, where any lower limit may be paired with any upper limit.

The spraying, exposing and curing steps may be conducted once or may be repeated to produce a structure including a substate and a membrane including at least one layer of the cured resin composition of the curable resin composition.

### Properties—Curable Resin Composition

In one or more embodiments, the curable resin composition has a viscosity of less than 150,000 cP at 1 rpm, as measured by a rotational viscometer. The viscosity of the curable resin composition by a rotational viscometer (Brookfield RV viscometer) is measured at a temperature of 23° C. with RV-06 spindle. In one or more embodiments, the curable resin composition has a viscosity in a range of from about 20,000 to about 150,000 cP at 1 rpm, as measured by a rotational viscometer, such as in a range of from a lower limit selected from any one of 20,000, 30,000, 40,000, and 50,000 cP, to an upper limit selected from any one of 60,000, 65,000, 70,000, 80,000, 90,000, 150,000, 125,000, and 150,000 cP, where any lower limit may be paired with any upper limit.

In one or more embodiments, the curable resin composition has a viscosity of less than 75,000 cP at 2 rpm, as measured by a rotational viscometer under the condition as described previously. In one or more embodiments, the curable resin composition has a viscosity in a range of from about 20,000 to about 75,000 cP at 2 rpm, as measured by a rotational viscometer, such as in a range of from a lower limit selected from any one of 20,000, 25,000, and 30,000 cP, to an upper limit selected from any one of 60,000, 65,000 70,000, and 75,000 cP, where any lower limit may be paired with any upper limit.

In one or more embodiments, the curable resin composition has a viscosity of less than 25,000 cP at 10 rpm, as measured by a rotational viscometer under the conditions as described previously. In one or more embodiments, the curable resin composition has a viscosity in a range of from about 5,000 to about 25,000 cP at 10 rpm, as measured by a rotational viscometer, such as in a range of from a lower limit selected from any one of 5,000, 6,000, and 7,000 cP, to an upper limit selected from any one of 20,000, 22,000, 24,000, and 25,000 cP, where any lower limit may be paired with any upper limit.

In one or more embodiments, the curable resin composition has a viscosity of less than 4.0 Pa-s at a temperature of 25° C. and a shear rate of 1000 1/s, as measured by a parallel plate rheometer. In one or more embodiments, the curable resin composition has a viscosity in Pa*s in a range of 1.0 to 4.5, such as in a range of from a lower limit selected from 1.0, 1.1, 1.2, 1.3, 1.4, and 1.5 Pa*s to an upper limit selected from any of 2.5, 3.0, 3.5, 4.0, and 4.5 Pa*s, where any lower limit may be paired with any upper limit.

In one or more embodiments, the curable resin composition has a thixotropic index of greater than 2.0. A “thixotropic index,” or a Brookfield thixotropic index, refers to a ratio of the viscosity of a composition at 2 rpm as measured by a rotational viscometer and the viscosity of the same composition at 10 rpm as measured by a rotational viscometer. In one or more embodiments, the curable resin composition has a thixotropic index in a range of 2 to 4, such as in a range of from a lower limit selected from 2, 2.25, and 2.5 to an upper limit selected from any of 3.5, 3.75, and 4, where any lower limit may be paired with any upper limit.

In one or more embodiments, the curable resin composition has a skin time of less than 150 minutes at 23° C. and 50% relative humidity (RH). A “skin time” refers to a time required for the curable resin composition exposed to moisture-containing air to develop a film on the surface exposed to the air. In one or more embodiments, the curable resin composition has a skin time at 23° C. and 50% RH in a range from about 10 minutes to about 150 minutes, such as in a range of from a lower limit selected from any one of 10, 20 30, 40, 50, 60, 70, and 80 minutes, to an upper limit selected from any one of 90, 100, 110, 120, 130, 140, and 150 minutes, where any lower limit may be paired with any upper limit.

In one or more embodiments, the curable resin composition has a skin time of less than 150 minutes at 23° C. and 50% RH, after the curable resin composition is stored for 4 weeks at 50° C. In one or more embodiments, the curable resin composition has a skin time at 23° C. and 50% RH, after 4-week storage at 50° C., in a range from about 10 minutes to about 150 minutes, such as in a range of from a lower limit selected from any one of 10, 20 30, 40, 50, 60, 70, and 80 minutes, to an upper limit selected from any one of 90, 100, 110, 120, 130, 140, and 150 minutes, where any lower limit may be paired with any upper limit.

In one or more embodiments, the curable resin composition is sprayable at a pressure of 4000 psi or less without the use of volatile organic compounds. Volatile organic compounds refer to organic compounds having a boiling point of less than 260° C. The sprayability of the curable resin composition is determined by using, for example, an airless hydraulic spray rig or a pressurized canister.

### Properties—Cured Resin Composition

The present disclosure generally relates to a cured resin composition of the curable resin composition. The curable resin composition may be cured by being exposed to moisture to produce the cured resin composition, whereby the liquid composition cures into a substantially solid, elastomeric rubber coating.

In one or more embodiments, the cured resin composition of the curable resin composition has a specific gravity in a range of 0.90 to 1.4, such as in a range of from a lower limit selected from 0.90, 1.0, 1.1, or 1.2 to an upper limit selected from any of 1.25, 1.3, 1.35, or 1.4, where any lower limit may be paired with any upper limit.

In one or more embodiments, the cured resin composition has a sag resistance as measured according to ASTM ASM-3, of 25 to 70 mils, such as in a range of from a lower limit selected from 25, 30, or 35 mils to an upper limit selected from any of 60, 65, or 70 mils, where any lower limit may be paired with any upper limit.

### Spray Index

In one or more embodiments, curable resin compositions may be characterized by a spray index (SI) according to the formula:

$$SI = μ * SG / TI$$

where μ is the viscosity in Pa*s determined at 1000 s⁻¹, SG is the specific gravity, and TI is the thixotropic index calculated by the 2 rpm/10 rpm Brookfield viscosity.

The viscosity of the curable resin composition, in Pa*s, (p) is measured using a parallel plate rheometer. The parallel plates are 15 mm in diameter and are adjusted to a 0.5 mm gap. The viscosity of the curable resin composition is obtained at 25° C. and a shear rate of 1000 s⁻¹. In one or more embodiments, the curable resin composition may have a viscosity in Pa*s in a range of 1.0 to 4.5, such as in a range of from a lower limit selected from 1.0, 1.1, 1.2, 1.3, 1.4, or 1.5 Pa*s to an upper limit selected from any of 2.5, 3.0, 3.5, 4.0, or 4.5 Pa*s, where any lower limit may be paired with any upper limit.

The specific gravity (SG) of the curable resin composition may be measured according to any suitable method for determining the specific gravity of a liquid. In one or more embodiments, the curable resin composition may have a specific gravity in a range of 0.90 to 1.4, such as in a range of from a lower limit selected from 0.70, 0.80, 0.90, 1.0, 1.1, or 1.2 to an upper limit selected from any of 1.25, 1.3, 1.35, or 1.4, where any lower limit may be paired with any upper limit.

The thixotropic index of the curable resin composition may be determined from the ratio of the Brookfield viscosities obtained at 2 rpm and 10 rpm. In one or more embodiments, the curable resin composition may have a thixotropic index in a range of 2 to 4, such as in a range of from a lower limit selected from 2, 2.25, or 2.5 to an upper limit selected from any of 3.5, 3.75, or 4, where any lower limit may be paired with any upper limit.

In one or more embodiments, curable resin compositions according to the present disclosure are sprayable. Sprayability is determined by evaluation of the spray pattern obtained by spraying the curable resin composition from an airless hydraulic spray rig. In embodiments, sprayability is determined using a Graco 675 sprayer; which is hopper fed and equipped with a 50 ft. ½” hose, 10 ft. ⅜” whip, and a 521 tip. Alternatively, a Graco X-Force handheld spray gun capable of 4000 psi with a 519 tip was used to confirm and evaluate the spray pattern.

In one or more embodiments, curable resin compositions which are sprayable have a spray index (SI) which may range from a lower limit selected from any one of 0.1, 0.2, 0.3, 0.4, or 0.5 to an upper limit selected from any one of 0.8, 0.9, 1.0, 1.1, 1.2, or 1.3, where any lower limit may be paired with any upper limit. Curable resin compositions according to the present disclosure may have a spray index of less than or equal to 1.3.

### Examples

TABLE 1-1

| | | Ex 1-3 | | Ex 4 | | Ex 5 | | Ex 6 | | Ex 7 | |
|---|---|---|---|---|---|---|---|---|---|---|---|
| Component | | (phr) | (%) | (phr) | (%) | (phr) | (%) | (phr | (%) | (phr | (%) |
| DMS MS Polymer | | 100 | 37.04 | 100 | 37.59 | 100 | 51.95 | 100 | 37.04 | 100 | 37.04 |
| TMS MS Polymer | | | | | | | | | | | |
| Plasticizer | A | | | | | | | | | | |
| | B | | | | | | | | | | |
| | C | | | | | | | | | | |
| | D | 40 | 14.81 | | | 40 | 20.78 | | | | |
| | E | | | | | | | 40 | 14.81 | | |
| | F | | | 40 | 15.04 | | | | | 40 | 14.81 |
| | G | 30 | 11.11 | 30 | 11.28 | 30 | 15.58 | 30 | 11.11 | 30 | 1.11 |
| Precipitated CaCO3 | | 50 | 18.52 | 50 | 18.80 | | | 50 | 18.52 | 50 | 18.52 |
| Ground CaCO3 | A | | | | | | | | | | |
| | B | 30 | 11.11 | 30 | 11.28 | | | 30 | 11.11 | 30 | 11.11 |
| Titanium Dioxide | | 5 | 1.85 | 5 | 1.88 | | | 5 | 1.85 | 5 | 1.85 |
| Carbon Black | | 0.25 | 0.09 | 0.25 | 0.09 | 1 | 0.52 | 0.25 | 0.09 | 0.25 | 0.09 |
| Thixotropic | | 0.75 | 0.28 | 0.75 | 0.28 | 7.5 | 3.90 | 0.75 | 0.28 | 0.75 | 0.28 |
| UVA | | 1 | 0.37 | 1 | 0.38 | 1 | 0.52 | 1 | 0.37 | 1 | 0.37 |
| HALS | | 1 | 0.37 | 1 | 0.38 | 1 | 0.52 | 1 | 0.37 | 1 | 0.37 |
| Dehydration | | 3 | 1.11 | 3 | 1.13 | 3 | 1.56 | 3 | 1.11 | 3 | 1.11 |
| Adhesion | | 3 | 1.11 | 3 | 1.13 | 3 | 1.56 | 3 | 1.11 | 3 | 1.11 |
| Catalyst | A | | | 2 | 0.75 | | | | | | |
| | B | 6 | 2.22 | | | 6 | 3.12 | 6 | 2.22 | 6 | 2.22 |

| | | | | | | | | | | |
|---|---|---|---|---|---|---|---|---|---|---|
| Total | 270 | 100 | 266 | 100 | 192.5 | 100 | 270 | 100 | 270 | 100 |

TABLE 1-2

| | | Comp Ex 1-3 | | Comp Ex 4 | | Comp Ex 5 | |
|---|---|---|---|---|---|---|---|
| Component | | (phr) | (%) | (phr) | (%) | (phr) | (%) |
| DMS MS Polymer | | 100 | 36.32 | 100 | 37 | 100 | 37.1 |
| TMS MS Polymer | | | | | | | |
| Plasticizer | A | 65 | 23.61 | | | | |
| | B | | | 25 | 9.26 | | |
| | C | | | 45 | 16.7 | | |
| | D | | | | | 40 | 14.9 |
| | E | | | | | | |
| | F | | | | | | |
| | G | | | | | 30 | 11.1 |
| Precipitated CaCO3 | | 20 | 7.26 | | | | |
| Ground CaCO3 | A | 60 | 21.79 | | | 85 | 31.6 |
| | B | | | | | | |
| Titanium Dioxide | | 20 | 7.26 | 85 | 31.5 | | |
| Carbon Black | | | | 0.25 | 0.09 | 0.25 | 0.09 |
| Thixotropic | | 1.5 | 0.54 | 0.75 | 0.28 | | |
| UVA | | 1 | 0.36 | 1 | 0.37 | 1 | 0.37 |
| HALS | | 1 | 0.36 | 1 | 0.37 | 1 | 0.37 |
| Dehydration | | 3 | 1.09 | 3 | 1.11 | 3 | 1.11 |
| Adhesion | | 3 | 1.09 | 3 | 1.11 | 3 | 1.11 |
| Catalyst | A | 0.8 | 0.29 | | | | |
| | B | | | 6 | 2.22 | 6 | 2.23 |

| | | | | | | |
|---|---|---|---|---|---|---|
| Total | 275 | 100 | 270 | 100 | 269.3 | 100 |

Formulations for Examples 1-7 and Comparative Examples 1-5 are provided in Tables 1-1 and 1-2.

TABLE 2-1

| Mixer Geometry (SP—Single Planetary, | | | | Ex 1 | Ex 2 | Ex 3 | Ex 4 |
|---|---|---|---|---|---|---|---|
| MS—Multishaft Anchor + 2 Dispersers) | | | | SP | MS | MS | SP |
| Test | Condition | | Units | Initial | Initial | Initial | Initial |
| Viscosity (RV) | 1 | rpm | cP | 51,000 | 65,000 | 59,000 | 96,000 |
| s06 (250 mL) | 2 | rpm | cP | 32,000 | 40,000 | 36,500 | 55,000 |
| | 10 | rpm | cP | 13,300 | 14,600 | 13,300 | 18,200 |
| | 20 | rpm | cP | 9,650 | 10,100 | 9,250 | 11,900 |
| | 50 | rpm | cP | 6,720 | 6,660 | 6,120 | |
| Brookfield Thixotropic | ([2 rpm]/[10 rpm]) | | | 2.41 | 2.74 | 2.74 | 3.02 |
| Index | | | | | | | |
| Rheometer - 15 mm | 1000 | 1/s | Pa*s | 2.40 | 2.32 | 2.29 | 1.78 |

| Parallel Plate | | | | | | |
|---|---|---|---|---|---|---|
| (0.5 mm gap, 25 C.) | | | | | | |
| Skin Time | 23 C./50% RH | min | 100 | 146 | 145 | 60 |
| Cure in depth | after 1 day | mm | 2.98 | 2.43 | 2.37 | 2.63 |
| | after 7 days | mm | 8.76 | 8.49 | 8.29 | 7.44 |
| Residual Tack | after 1 day | | 7 | 7 | 7 | 7 |
| 1 = Tacky, 8 = No Tack | after 7 days | | 7 | 7 | 7 | 7 |
| Hardness (Shore A) | | | 18 | 15 | 15 | 22 |
| Mechanical Properties | M100 | MPa | 0.33 | 0.27 | 0.30 | 0.42 |
| ASTM D412 | TB | MPa | 0.66 | 0.53 | 0.48 | 0.91 |
| | EB | MPa | 317 | 313 | 284 | 255 |

| | | | | | |
|---|---|---|---|---|---|
| Specific Gravity—SG | calculated | 1.24 | 1.24 | 1.24 | 1.21 |
| Sag Resistance | (mils) | 35 | 35 | 35 | 60 |
| (ASTM ASM-3) | | | | | |
| Spray Pattern at 4000 psi | Graco 675 Hopper Fed, | — | ◯ | ◯ | — |
| ◯ = Acceptable | 50 ft ½″ hose, 10 ft | | | | |
| X = Unacceptable | ⅜″ whip, 521 Tip | | | | |
| Spray Pattern at 4000 psi | Graco X-Force, 519 tip | ◯ | — | — | ◯ |
| ◯ = Acceptable | | | | | |
| X = Unacceptable | | | | | |
| Spray Index | =1000 1/s Viscosity/ | 1.24 | 1.05 | 1.03 | 0.71 |
| (lower is better) | Thix Index * SG | | | | |

TABLE 2-2

| Mixer Geometry (SP—Single Planetary, | | | Ex 5 | Ex 6 | Ex 7 |
|---|---|---|---|---|---|
| MS—Multishaft Anchor + 2 Dispersers) | | | SP | SP | SP |
| Test | Condition | Units | Initial | Initial | Initial |
| Viscosity (RV) | 1 rpm | cP | 113,000 | 48,000 | 62,000 |
| s06 (250 mL) | 2 rpm | cP | 67,500 | 30,000 | 38,000 |
| | 10 rpm | cP | 23,100 | 12,000 | 14,300 |
| | 20 rpm | cP | | 8,950 | 10,500 |
| | 50 rpm | cP | | 6,380 | 7,280 |
| Brookfield Thixotropic | ([2 rpm]/[10 rpm]) | | 2.92 | 2.50 | 2.66 |
| Index | | | | | |
| Rheometer-15 mm | 1000 1/s | Pa*s | 2.45 | 2.33 | 2.19 |
| Parallel Plate | | | | | |
| (0.5 mm gap, 25 C) | | | | | |
| Skin Time | 23 C/50% RH | min | 90 | 111 | 110 |
| Cure in depth | after 1 day | mm | 3.83 | 4.03 | 2.84 |
| | after 7 days | mm | 8.26 | 10.84 | 6.96 |
| Residual Tack | after 1 day | | 7 | 7 | 7 |
| 1 = Tacky, 8 = No Tack | after 7 days | | 7 | 7 | 7 |
| Hardness (Shore A) | | | 12 | 14 | 13 |
| Mechanical Properties | M100 | MPa | 0.27 | 0.30 | 0.29 |
| ASTM D412 | TB | MPa | 0.35 | 0.43 | 0.48 |
| | EB | MPa | 341 | 236 | 234 |
| Specific Gravity—SG | calculated | | 0.98 | 1.24 | 1.20 |
| Sag Resistance | (mils) | | 60 | 35 | 40 |
| (ASTM ASM-3) | | | | | |
| Spray Pattern at 4000 psi | Graco 675 Hopper Fed, 50 ft 1/2″ | | — | — | — |
| O = Acceptable | hose, 10 ft 3/8″ whip, 521 Tip | | | | |
| X = Unacceptable | | | | | |
| Spray Pattern at 4000 psi | Graco X-Force, 519 tip | | O | O | O |
| O = Acceptable | | | | | |
| X = Unacceptable | | | | | |

| | | | | |
|---|---|---|---|---|
| Spray Index | =1000 1/s Viscosity/ | 0.82 | 1.15 | 0.99 |
| (lower is better) | Thix Index * SG | | | |

TABLE 2-3

| | | | | Comp | Comp | Comp | Comp |
|---|---|---|---|---|---|---|---|
| Mixer Geometry (SP—Single Planetary, | | | | Ex 1 | Ex 2 | Ex 3 | Ex 4 |
| MS—Multishaft Anchor + 2 Dispersers) | | | | SP | MS | MS | SP |
| Test | Condition | | Units | Initial | Initial | Initial | Initial |
| Viscosity (RV) | 1 | rpm | cP | 125,000 | 109,000 | 105,000 | 20,000 |
| s06 (250 mL) | 2 | rpm | cP | 76,500 | 65,000 | 62,500 | 16,500 |
| | 10 | rpm | cP | 28,900 | 23,300 | 22,200 | 10,300 |
| | 20 | rpm | cP | 20,450 | 15,950 | 15,300 | 8,750 |
| | 50 | rpm | cP | | 10,460 | 10,300 | 7,380 |

| Brookfield Thixotropic | ([2 rpm]/[10 rpm]) | | 2.65 | 2.79 | 2.82 | 1.60 |
|---|---|---|---|---|---|---|
| Index | | | | | | |
| Rheometer - 15 mm | 1000 1/s | Pa*s | 4.21 | 3.31 | 3.72 | 3.17 |
| Parallel Plate | | | | | | |
| (0.5 mm gap, 25 C.) | | | | | | |
| Skin Time | 23 C./50% RH | min | 112 | 122 | 120 | 92 |
| Cure in depth | after 1 day | mm | 3.01 | 2.48 | 2.57 | 3.68 |
| | after 7 days | mm | 7.40 | 8.01 | 8.09 | 9.81 |
| Residual Tack | after 1 day | | 7 | 7 | 7 | 7 |
| 1 = Tacky, 8 = No Tack | after 7 days | | 7 | 7 | 7 | 7 |
| Hardness (Shore A) | | | 25 | 22 | 23 | 19 |
| Mechanical Properties | M100 | MPa | 0.50 | 0.46 | 0.45 | 0.51 |
| ASTM D412 | TB | MPa | 0.93 | 1.08 | 1.00 | 1.60 |
| | EB | MPa | 241 | 323 | 294 | 242 |

| | | | | | |
|---|---|---|---|---|---|
| Specific Gravity—SG | calculated | 1.30 | 1.30 | 1.30 | 1.42 |
| Sag Resistance (ASTM | (mils) | 60 | 60 | 60 | <14 |
| ASM-3) | | | | | |
| Spray Pattern at 4000 psi | Graco 675 Hopper Fed, | — | X | X | — |
| ◯ = Acceptable | 50 ft ½″ hose, 10 ft | | | | |
| X = Unacceptable | ⅜″ whip, 521 Tip | | | | |
| Spray Pattern at 4000 psi | Graco X-Force, 519 tip | — | — | — | X |
| ◯ = Acceptable | | | | | |
| X = Unacceptable | | | | | |
| Spray Index (lower is | =1000 1/s Viscosity/ | 2.07 | 1.54 | 1.72 | 2.82 |
| better) | Thix Index * SG | | | | |

TABLE 2-4

| | | | Comp | Comp |
|---|---|---|---|---|
| Mixer Geometry (SP—Single Planetary, | | | Ex 5 | Ex 6 |
| MS—Multishaft Anchor + 2 Dispersers) | | | SP | Unknown |
| Test | Condition | Units | Initial | Initial |
| Viscosity (RV) | 1 rpm | cP | 2,000 | 25,000 |
| s06 (250 mL) | 2 rpm | cP | 2,000 | 18,500 |
| | 10 rpm | cP | 2,000 | 9,300 |
| | 20 rpm | cP | 2,000 | 7,500 |
| | 50 rpm | cP | 1,980 | 6,100 |
| Brookfield Thixotropic | ([2 rpm]/[10 rpm]) | | 1.00 | 1.99 |
| Index | | | | |
| Rheometer-15 mm | 1000 1/s | Pa*s | 2.42 | 3.28 |
| Parallel Plate | | | | |
| (0.5 mm gap, 25 C) | | | | |
| Skin Time | 23 C/50% RH | min | 174 | 75 |
| Cure in depth | after 1 day | mm | 4.25 | 2.56 |
| | after 7 days | mm | 9.17 | 6.76 |
| Residual Tack | after 1 day | | 7 | 5 |
| 1 = Tacky, 8 = No Tack | after 7 days | | 7 | 7 |
| Hardness (Shore A) | | | 11 | 15 |
| Mechanical Properties | M100 | MPa | 0.27 | 0.31 |
| ASTM D412 | TB | MPa | 0.49 | 0.70 |
| | EB | MPa | 210 | 194 |
| Specific Gravity—SG | calculated | | 1.23 | 1.35 |
| Sag Resistance (ASTM | (mils) | | <14 | 16 |
| ASM-3) | | | | |
| Spray Pattern at 4000 psi | Graco 675 Hopper Fed, 50 ft 1/2″ | | — | X |
| O = Acceptable | hose, 10 ft 3/8″ whip, 521 Tip | | | |
| X = Unacceptable | | | | |
| Spray Pattern at 4000 psi | Graco X-Force, 519 tip | | X | X |
| O = Acceptable | | | | |
| X = Unacceptable | | | | |

| | | | |
|---|---|---|---|
| Spray Index (lower is | =1000 1/s Viscosity/ | 2.97 | 2.23 |
| better) | Thix Index * SG | | |

Results of rheological testing, mechanical testing, curing performance, and spray performance are provided in Tables 2-1, 2-2, 2-3, and 2-4.

### Physical Properties—Cured Resin Compositions

Test samples of cured resin composition were prepared from the resin compositions of EXAMPLES 1-6 and COMPARATIVE EXAMPLES 1-7, and various physical/mechanical properties of the cured resin compositions were obtained as described below.

The residual tack of each cured resin composition was determined based on a Likert scale of 1 to 8, where the higher number corresponds to lower level of tack, and the residual tack of 8 means there is no tack.

The hardness of each cured resin compositions was determined by pressing a durometer against the surface of the cured test samples. Type Shore A scale was used to determine the hardness.

The cured test samples having a thickness of approximately 3 mm (and actual thickness confirmed with Peacock Model PDN-21) were cut using a type “C” die, as defined in ASTM D412, and a tensile test was conducted using a tensile machine Shimadzu AGS-X. The test was conducted in accordance with ASTM D412 to obtain a tensile stress at 100% elongation (M100), a tensile strength at break, and an elongation at break.

The specific gravity of each cured resin composition was determined as the inverse of: the sum of the loading of each component of the cured resin composition in wt % multiplied by the specific gravity of each component of the cured resin composition.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A curable resin composition comprising:
a polymer (P); and
at least one plasticizer and/or a diluent;
wherein the curable resin composition has a spray index (SI) according to:
$$( SI ) = μ * SG / TI$$
wherein μ is the viscosity in Pa*s determined at 1000 s⁻¹;
wherein TI is the thixotropic index calculated by the 2 rpm/10 rpm Brookfield viscosity; and
wherein SG is the specific gravity; and
wherein the spray index is less than 1.3.

2. The curable resin composition according to claim 1, wherein the polymer (P) is moisture curable.

3. The curable resin composition according to claim 1, wherein the polymer (P) is a polymer comprising reactive silicon groups represented by the general formula (2): 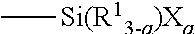
wherein R¹ represents an alkyl group having 1 to 20 carbon atoms, an aryl group having 6 to 20 carbon atoms, or an aralkyl group having 7 to 20 carbon atoms;
wherein X represents a hydrolyzable group, wherein each X is the same or different when two or more X are present;
a is an integer from 1 to 3, where a is 1, each R¹ may be the same or different; and
when a is 2 or 3, each X may be the same or different.

4. The curable resin composition according to claim 1, wherein the polymer (P) is in an amount of 10 to 60 wt %.

5. The curable resin composition according to claim 1, wherein the at least one plasticizer and/or diluent are in an amount of 10 to 60 wt %.

6. The curable resin composition according to claim 1, wherein the curable resin composition has a viscosity μ, in Pa*s determined at 1000 s⁻¹, of 1.0 to 4.5.

7. The curable resin composition according to claim 1, wherein the curable resin composition has a thixotropic index (TI), calculated by the 2 rpm/10 rpm Brookfield viscosity, of 2 to 4.

8. The curable resin composition according to claim 1, wherein the curable resin composition has a specific gravity (SG) of 0.90 to 1.4.

9. The curable resin composition according to claim 1, wherein the polymer (P) comprises a polyether main chain.

10. The curable resin composition according to claim 10, wherein the polyether main chain is polyoxypropylene.

11. The curable resin composition according to claim 1, wherein the curable resin composition further comprises at least one catalyst.

12. The curable resin composition according to claim 11, wherein the catalyst is an organotin catalyst.

13. The curable resin composition according to claim 1, wherein the curable resin composition further comprises at least one additive.

14. The curable resin composition according to claim 13, wherein the at least one additive is selected from the group consisting of:
polymers different from the polymer (P),
fillers,
dehydration agents,
stabilizers, and
combinations thereof.

15. The curable resin composition according to claim 1, wherein the plasticizers and/or diluents comprised in the curable resin composition have a boiling point of greater than or equal to 260° C.

16. The curable resin composition of claim 1, wherein the curable resin composition is sprayable with an airless hydraulic spray rig at a pressure of 4000 psi or less.

17. The curable resin composition of claim 1, further comprising at least one higher viscosity plasticizer having a Brookfield viscosity of at least 25 cP at 23° C.

18. A cured resin composition of the curable resin composition of claim 1.

19. The cured resin composition of claim 18, wherein the cured resin composition has a sag resistance of greater than or equal to 20 mil when sprayed on a vertical substrate.

20. A structure, comprising:
a substrate; and
a membrane disposed on the substrate,
wherein the membrane comprises at least one layer of the cured resin composition of claim 18.

21. A method comprising:
providing a curable resin composition of claim 1; and
spraying the curable resin composition onto a substrate.

22. The method of claim 21, further comprising:
exposing the sprayed curable resin composition to moisture; and
curing the sprayed curable resin composition for a duration of at least 24 hours to produce a cured resin composition of the curable resin composition.

23. The method according to claim 21, wherein the spraying is at a pressure of less than 4000 psi.

24. The method according to claim 21, wherein the substrate is oriented strand board, plywood, fiberboard, foam, gypsum board, a concrete masonry unit, or cast concrete.
